(19) United States
(12) Patent Application Publication
(10) Pub. No.: US 2013/0036012 A1
(43) Pub. Date: Feb. 7, 2013

(54) LOCATION-BASED SERVICE SYSTEM

(71) Applicants: Mao-Hsi LIN, Taipei City (TW); Hsiu-Ping Lin, New Taipei City (TW)

(72) Inventors: Mao-Hsi LIN, Taipei City (TW); Hsiu-Ping Lin, New Taipei City (TW)

(21) Appl. No.: 13/564,115

(22) Filed: Aug. 1, 2012

(30) Foreign Application Priority Data
Aug. 1, 2011 (TW) 100127157

(51) Int. Cl. G06Q 30/02

(52) U.S. Cl. 705/14.58

(57) ABSTRACT

A computer-implemented method of managing location-based advertising in a location-based service system between a server side and client sides, said method comprising storing member accounts registered in the location-based service system in first database on the server side; storing advertisement files in second database on the server side; and selecting a first member account from the member accounts on the server side, distance between member coordinate corresponding with the selected first member account and advertisement coordinate corresponding with specified one of the advertisement files is smaller than or equal to first distance; transmitting at least one of the specified one of the advertisement files or link corresponding with the specified one of the advertisement files to a first client side corresponding with the selected first member account from the server side; and increasing value of points of the selected first member account by first amount on the server side.

### BACKGROUND OF THE INVENTION

The invention generally relates to a service system and, more particularly, to a location-based service system for managing or/and evaluating location-based advertising.

With the progress in the technology of wireless or wired communication network system, location-based service is popularly provided. Such location-based service may include positioning which may be achieved by GPS, APGS or positioning devices for 3G mobile communication systems. Furthermore, such location-based service may include advertising, which may be named “location-based advertising”. That is, advertisement information may be provided to users of the computing device operating in the wireless or wired communication network system. However, undesired advertisement information may disturb the users. Moreover, to provide such location-based advertising service, location information of the users must be obtained and accessed by the wireless or wired communication network system which in turn causes invasion of the users' privacy and security.

It is therefore desirable to have a location-based service system that is able to provide location-based advertising service considering privacy and security.

### BRIEF SUMMARY OF THE INVENTION

Examples of the present invention may provide a computer-implemented method of managing location-based advertising in a location-based service system between a server side and client sides, said method comprising storing a plurality of member accounts registered in the location-based service system in a first database on the server side; storing a plurality of advertisement files in a second database on the server side; and selecting a first member account from the plurality of member accounts on the server side, wherein a distance between a member coordinate corresponding with the selected first member account and an advertisement coordinate corresponding with a specified one of the advertisement files is smaller than or equal to a first distance; transmitting at least one of the specified one of the advertisement files or a link corresponding with the specified one of the advertisement files to a first client side corresponding with the selected first member account from the server side; and increasing a value of points of the first member account by a first amount on the server side.

Other examples of the present invention may provide a computer-implemented method of managing location-based advertising in a location-based service system between a server side and client sides, said method comprising storing a plurality of member accounts registered in the location-based service system in a first database on the server side; storing a plurality of advertisement files in a second database on the server side; and selecting a first member account from the plurality of member accounts on the server side, wherein a distance between a member coordinate corresponding with the selected first member account and an advertisement coordinate corresponding with a specified one of the advertisement files is smaller than or equal to a first distance; transmitting at least one of the specified one of the advertisement files or a link corresponding with the specified one of the advertisement files to a first client side corresponding with the selected first member account from the server side; updating the member coordinate corresponding with the selected first member account on the server side according to a current location of the first client side; and if a distance between the updated member coordinate of the selected first member account and the advertisement coordinate of the specified one advertisement is smaller than or equal to a second distance, increasing the value of the points of the selected first member account by at least one of a first amount or a second amount on the server side.

Still other examples of the present invention may provide a computer-implemented method of managing location-based advertising in a location-based service system between a server side and a first client side or a second client side, said method comprising storing a plurality of member accounts registered in the location-based service system in a first database on the server side; storing a plurality of advertisement files in a second database on the server side; and selecting a first member account from the plurality of member accounts on the server side, wherein a distance between a member coordinate corresponding with the selected first member account and an advertisement coordinate corresponding with a specified one of the advertisement files is smaller than or equal to a first distance; transmitting at least one of the specified one of the advertisement files or a link corresponding with the specified one of the advertisement files to a first client side corresponding with the selected first member account from the server side; receiving a first notice on the server side from the first client side or the second client side, wherein the second client side corresponds with the selected one of the advertisement files, wherein the first notice is generated on the first client side or the second client side if a distance between a location of the first client side and the advertisement coordinate of the specified one advertisement is smaller than or equal to a second distance to achieve a near-field connection (NFC) between the first client side and the second client side; and at least one of increasing the value of the points of the selected first member account by a second amount or decreasing a value of points of a third account corresponding with the specified ones of the advertisement files by a third amount on the server side.

Still further examples of the present invention may provide a computer-implemented method of managing location-based advertising in a location-based service system between a server side and a first client side or a second client side, said method comprising storing a plurality of member accounts registered in the location-based service system in a first database on the server side; storing a plurality of advertisement files in a second database on the server side; and selecting a first member account from the plurality of member accounts on the server side, wherein a distance between a member coordinate corresponding with the selected first member account and an advertisement coordinate corresponding with a specified one of the advertisement files is smaller than or equal to a first distance; transmitting at least one of the specified one of the advertisement files or a link corresponding with the specified one of the advertisement files to a first client side corresponding with the selected first member account from the server side; receiving a second notice on the server side from the first client side or the second client side, wherein the second client side corresponds with the selected one of the advertisement files, wherein the second notice is generated on the first client side or a second client side if the first client side is in a range capable of coupling with the second client side via wireless-fidelity (Wi-Fi); and at least one of increasing the value of the points of the selected first member account by a second amount or decreasing a value of points of a third account corresponding with the specified ones of the advertisement files by a third amount on the server side.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The following detailed description of the invention will be better understood when read in conjunction with the appended drawings. For the purpose of illustrating the invention, examples are shown in the drawings. It should be understood, however, that the invention is not limited to the precise arrangements and instrumentalities shown in the examples.

In the drawings:

FIG. 1A is a block diagram of the location-based service system in accordance with an example of the present invention;

FIG. 1B is a block diagram of the location-based service system in accordance with another example of the present invention;

FIG. 2 illustrates the data structure of the advertisement database in accordance with an example of the present invention;

FIGS. 3A and 3B illustrate the data structure of the member database in accordance with an example of the present invention;

FIG. 4 is a block diagram of the location-based service system, the first computing device and the second computing device in accordance with another example of the present invention;

FIG. 5A is a block diagram of the location-based service system in accordance with yet another example of the present invention;

FIGS. 5B to 5D illustrate the advertisement effect value in accordance with an example of the present invention

FIG. 6A is a block diagram of the location-based service system and the first computing devices and in accordance with still another example of the present invention.

FIGS. 6B to 6D illustrate the searching scheme of the searching module in accordance with an example of the present invention.

FIG. 7A is a block diagram of the location-based service system and the first computing device in accordance with further another example of the present invention.

FIG. 7B is a block diagram of the location-based service system and the first computing device in accordance with still further another example of the present invention.

FIG. 7C illustrates the point-updating scheme of the location-based service system in accordance with an example of the present invention.

FIG. 8 is a block diagram of the location-based service system and the second computing device in accordance with a further example of the present invention; and

FIG. 9 is a block diagram of the location-based service system, the second computing device and the first computing devices in accordance with an example of the present invention.

### DETAILED DESCRIPTION OF THE INVENTION

Reference will now be made in detail to the present examples of the invention, examples of which are illustrated in the accompanying drawings. Wherever possible, the same reference numbers will be used throughout the drawings to refer to the same or like parts.

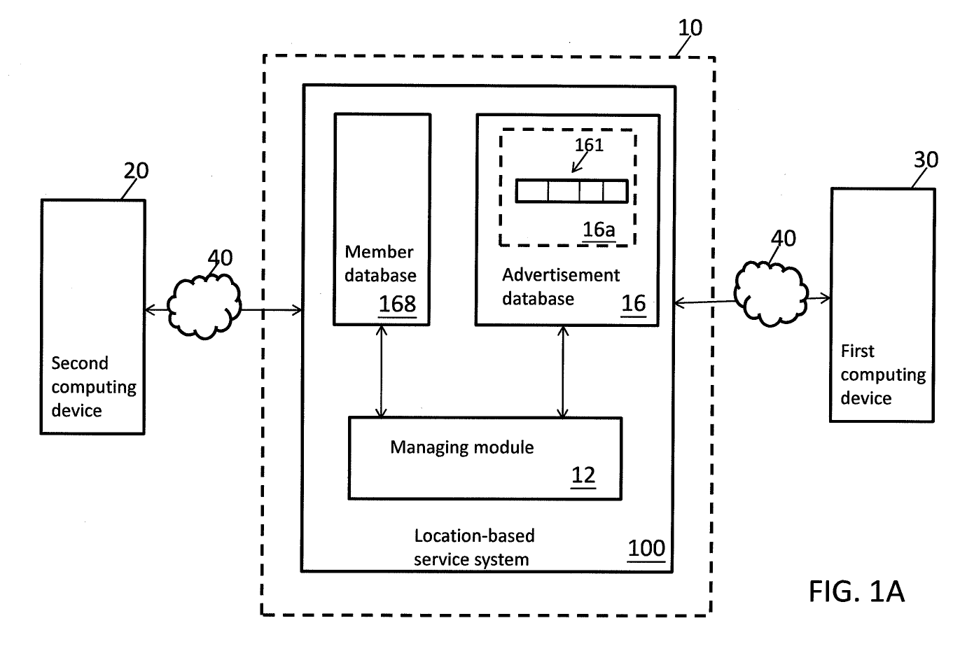

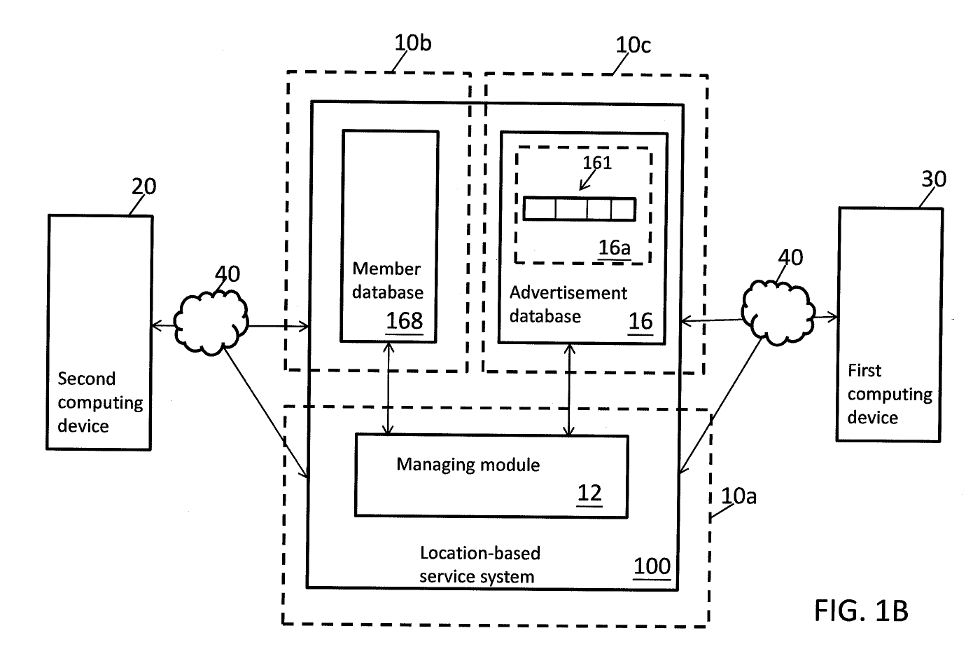

FIG. 1A is a block diagram of the location-based service system 100 in accordance with an example of the present invention. Referring to FIG. 1A, the location-based service system 100 may be disposed in a server 10, and the server 10 may be communicatively coupled with at least one first computing device 30 or/and at least one second computing device 20 through wired or wireless communication network or cellular communication network 40. The at least one first computing device 30 or the at least one second computing device 20 may include but not limited to a television, a personal computer, a notebook, a mobile phone, a navigator, a digital camera, a video camera, a projector, a device with a projector module, a portable media player, an E-book, a tablet computer, a portable game player, a car computer or a router.

The location-based service system 100, which may be disposed in a server 10, may include a managing module 12, a member database 168 and an advertisement database 16. However, the managing module 12, the member database 168 or the advertisement database 16 may not be limited to as being disposed in a single server (i.e. server 10). In another example, the managing module 12, the member database 168 and the advertisement database 16 may be disposed in separated servers respectively, as shown in FIG. 1B. In FIG. 1B, the managing module 12, the member database 168 and the advertisement database 16 may be disposed in a first server 10a, a second server 10b and a third server 10c respectively. In still another example, the location-based service system 100 may be disposed in and performed by more than three servers, in the manner of cluster (not shown). In such case, sub-modules of the managing module 12 may be disposed in different servers respectively, while the member database 168 and the advertisement database 16 may be disposed in a first storage device and second storage device respectively (not shown).

In the examples described in the former paragraphs by reference to FIGS. 1A and 1B, the server 10, first server 10a, second server 10b and third server 10c may be considered as a “server side” associated with the location-based service system 100, while the first computing device 30 and the second computing device 20 may be considered as “client sides” associated with the location-based service system 100. Specifically, the first computing device 30 and the second computing device 20 may be considered as a “first client side” and a “second client side” associated with the location-based service system 100 respectively. Such terminologies “server side”, “client side”, “first client side” and “second client side” may be employed throughout the whole specification. More particularly, a user of the first computing device 30 may be considered as a user on the first client side, while a user of the second computing device 20 may be considered as a user on the second client side.

Specifically, the managing module 12 may be communicatively coupled with the advertisement database 16 and the member database 168. The managing module 12 may include a webpage program, a command list script program or a graphics user interface (GUI) application program that may be executed by the server 10, the at least one first computing device 30 or the at least one second computing device 20. In one example, the webpage program, the command list script program or the GUI application program may include but not limited to a personal home page (PHP) program, a Java sever pages (JSP) program or an active server pages (ASP) program. Furthermore, the advertisement database 16 or member database 168 may include but not limited to a data structure which may be installed or stored in a storage device (e.g., a hard-drive) and may be accessed through a structured query language (SQL).

In operation, by executing the webpage program, the command list script program or the GUI application program of the managing module 12, a webpage or a GUI which may be compatible with a browser of the at least one first computing device 30 or the at least one second computing device 20, may be generated. Through the generated webpage or GUI on the at least one first or second computing device, users of the at least one first or second computing device may interact with the location-based service system 100 and in turn access data stored in the advertisement database 16 or the member database 168. For example, by executing accessing commands of the managing module 12, the data stored in the advertisement database 16 or the member database 168 may be accessed, edited, modified or deleted.

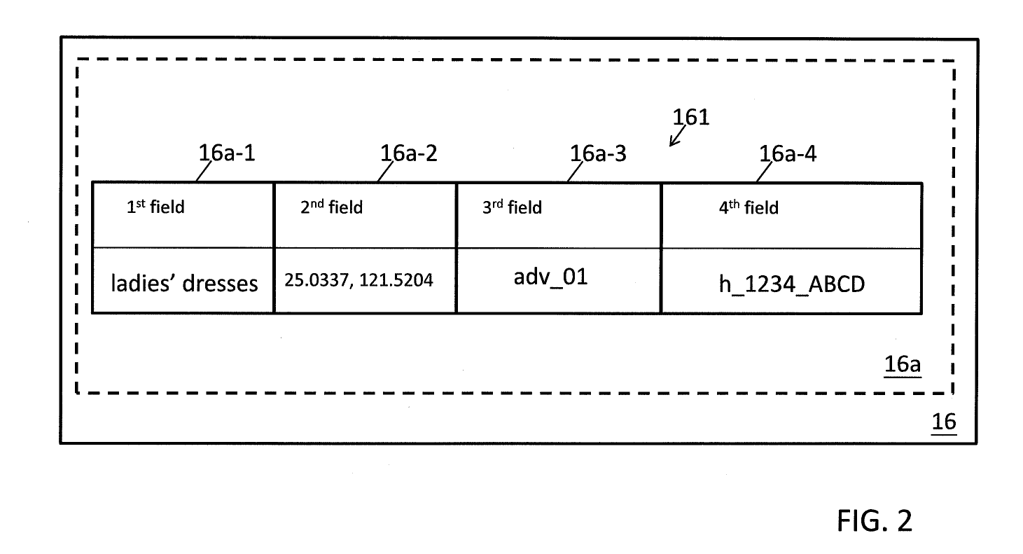

In one example, users of the at least one first or second computing device may post an advertisement on the location-based service system 100. An advertisement file 16a, which may correspond with the posted advertisement and compatible with the data structure 161 of the advertisement database 16, may be generated and stored in the advertisement database 16. In another example, the advertisement file 16a may have a file name and a physical address. On the other hand, the advertisement may have a corresponding geographic location and a title. Such file name, physical address, geographic location or title may be stored in corresponding fields of the data structure 161 of the advertisement file 16a, as will be discussed in the following paragraphs by reference to FIG. 2.

FIG. 2 illustrates the data structure 161 of the advertisement database 16 in accordance with an example of the present invention. Referring to FIG. 2, the data structure 161 of the advertisement file 16a may include a first field 16a-1, a second field 16a-2, a third field 16a-3 or a fourth field 16a-4. Specifically, the advertisement may have a title which may briefly describe the content of the advertisement. Such a title may be stored in the first field 16a-1. In one example, the advertisement may have a corresponding geographic location that may include a set of longitude-latitude coordinate at which the advertisement may be located. Such a set of longitude-latitude coordinate may be denoted as “advertisement coordinate” of the advertisement, and such advertisement coordinate may be stored in the second field 16a-2. Moreover, the advertisement file 16a may have a file name and a physical address with which the advertisement file 16a may be stored in a storage device of the server 10. The file name and physical address may be stored in the third field 16a-3 and the advertisement fourth field 16a-4 respectively

In one example, a user of a second computing device 20 may have a shop or a store which is located in a first address, selling merchandise such as dresses for ladies. The first address may correspond with a set of longitude-latitude coordinate of “25.0337, 121.5204”, and the merchandise may be titled as “ladies' dresses”. The user of the second computing device 20 may post an advertisement for the merchandise on the location-based service system 100 through the second computing device 20, and a corresponding advertisement file 16a may then be generated and stored in the advertisement database 16. The generated advertisement file 16a may have a file name of “adv_{—}01” and a physical address of “h_{—}1234_ABCD” in the storage device of the server 10. Accordingly, “ladies' dresses”, “25.0337, 121.5204”, “adv_{—}01” and “h_{—}1234_ABCD” may be stored in the first field 16a-1, the second field 16a-2, the third field 16a-3 and the fourth field 16a-4 in the data structure 161 of the advertisement file 16a.

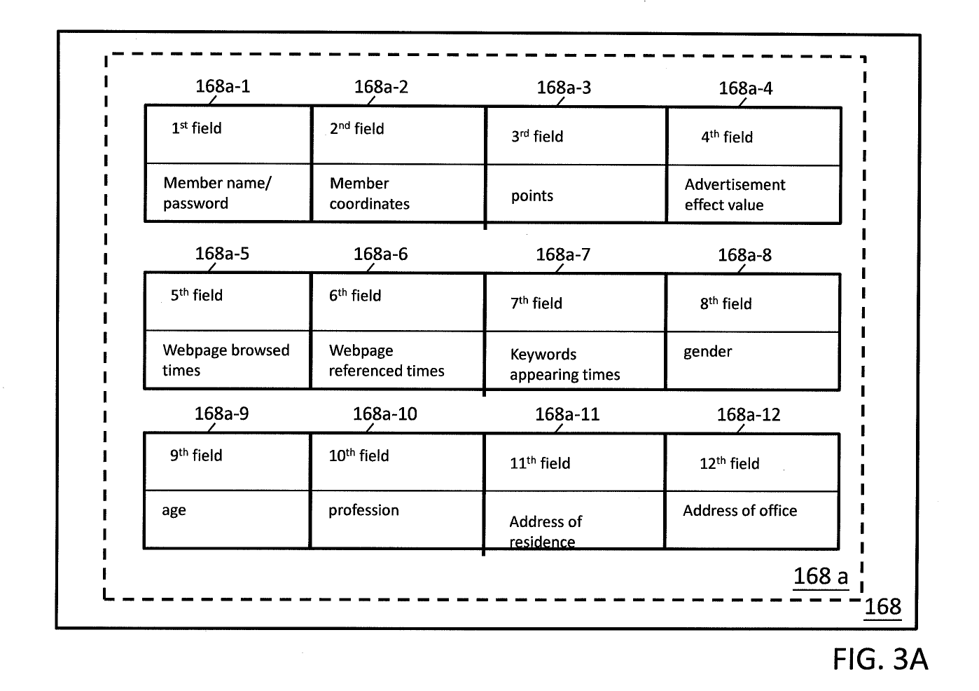

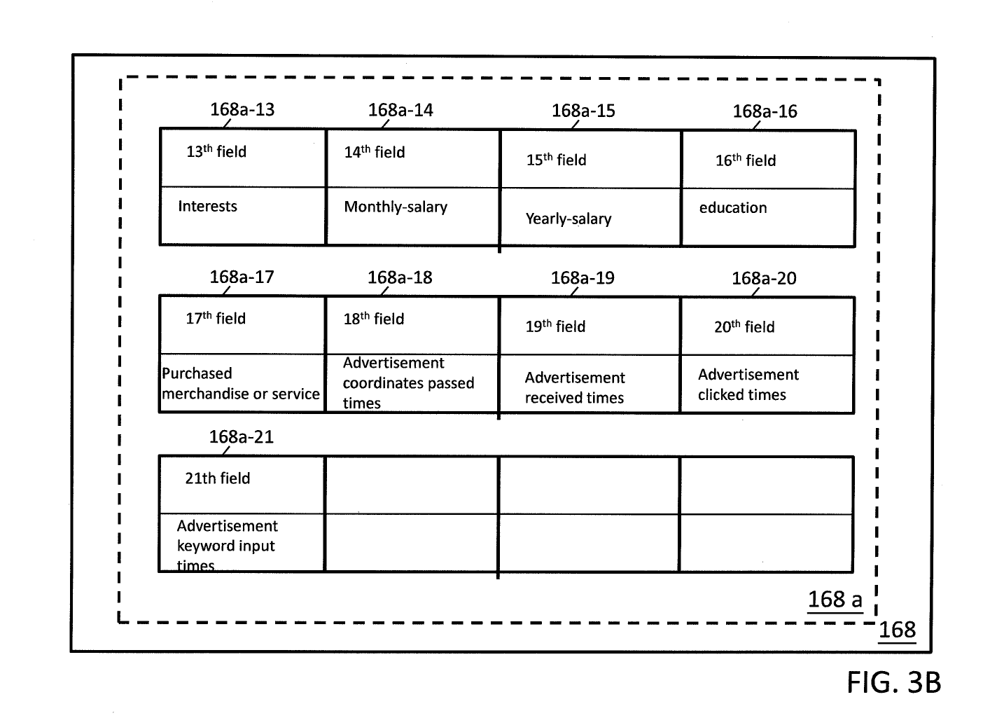

FIGS. 3A and 3B illustrate the data structure of the member database 168 in accordance with an example of the present invention. Referring to FIG. 3A, the user of the second computing device 20 (i.e., the user on a second client side) may register as a member (denoted as “member A”) of the location-based service system 100 through the second computing device 20. In other words, after registering as the member of the location-based service system 100, the user of the second computing device 20 (or user on the second client side) may be considered as a member on the client side associated with the location-based service system 100. In order to register as a member, the user of the second computing device 20 may directly input his/her profile to the location-based service system 100. Alternatively, the user of the second computing device 20 may upload his/her profile to the location-based service system 100 through the second computing device 20. Furthermore, a member account 168a corresponding with “member A” may be generated and stored in the member database 168, as shown in FIG. 3A. The profile of “member A” may be stored in corresponding fields of the member account 168a. The member account 168a may be stored in the member database 168 disposed on the server 10 (or separately disposed on the first server 10a, second server 10b and the third server 10c), therefore, the member account 168a may be considered as “member account on the server side”. Likewise, “member account 168b”, “member account 168c” and “member account 168d” as will be described in the following paragraphs may be also considered as “member accounts on the server side”.

Specifically, the profile of “member A” may include a member name and a password for logging in the location-based service system 100. Such member name and password may be stored in a corresponding field, such as the first field 168a-1 of the member account 168a in the member database 168 as shown in FIG. 3A. Furthermore, the profile of “member A” may further include a set of longitude-latitude coordinate corresponding with the current location “member A”. The set of longitude-latitude coordinate may be denoted as “member coordinate” of “member A”. Such member coordinate may be stored in a corresponding field, such as the second field 168a-2. In one example, the member coordinate may also serve as the advertisement coordinate of the advertisement posted by “member A”.

In another example, an advertisement provider who may post an advertisement on the location-based service system 100 may not register as a member of the location-based service system 100. Such an advertisement provider may not have corresponding member coordinate stored in the member database 168 to serve as the advertisement coordinate. For such case, the administrator of the location-based service system 100 may directly input a set of longitude-latitude coordinate to serve as the advertisement coordinate. Alternatively, the administrator of the location-based service system 100 may input location information corresponding with the advertisement, and such location information may then be converted to a set of longitude-latitude coordinate to serve as the advertisement coordinate.

In still another example, an advertisement provider who may post an advertisement on the location-based service system 100 may not post the advertisement through his/her own second computing device 20. In this case, location information corresponding with the advertisement provider may not be directly converted to member coordinate through the second computing device 20 to serve as the advertisement coordinate. For such case, the administrator of the location-based service system 100 may directly input a set of longitude-latitude coordinate to serve as the advertisement coordinate.

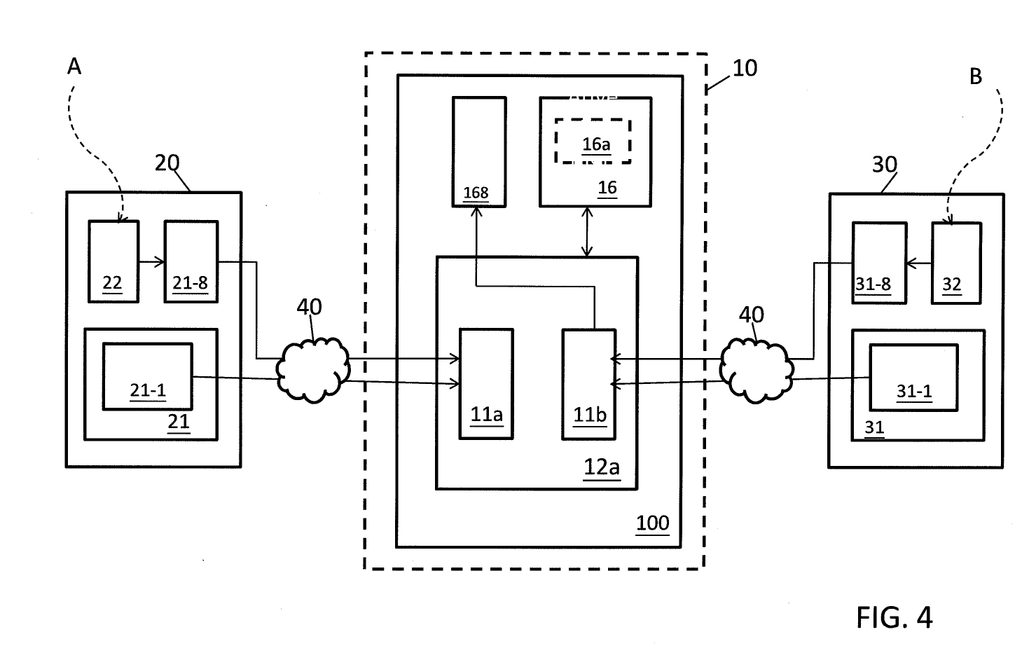

As aforementioned, if the advertisement provider has registered as a member of the location-based service system 100 (i.e., the advertisement provider may be considered as a member on the client side associated with the location-based service system 100), he/she can use the member coordinate of the advertisement provider as the advertisement coordinate. The member coordinate may be directly obtained by a second positioning module 22 of the second computing device 20 and received by a second location module 11a of the managing module 12. Alternatively, the member coordinate may be converted from the location information corresponding with the advertisement provider, as will be described in the following paragraphs by reference to FIG. 4.

FIG. 4 is a block diagram of the location-based service system 100, the first computing device 30 and the second computing device 20 in accordance with another example of the present invention. Referring to FIG. 4, the managing module 12a may include a first location module 11b and a second location module 11a. Furthermore, the first computing device 30 may include a first positioning module 32, a first location information transmitting module 31-8 coupled with the first positioning module 32 and a screen 31. Similar to the first computing device 30, the second computing device 20 may include a second positioning module 22, a second location information transmitting module 21-8 coupled with the second positioning module 22 and a screen 21.

In one example, the first positioning module 32 may include a global position satellite (GPS) chipset or a GPS module. The GPS chipset or GPS module may receive a satellite signal (denoted as signal “B”) and convert the received satellite signal B to a set of longitude-latitude coordinate, which correspond with the current location of the first computing device 30 and in turn the current location of the user of the first computing device 30. The set of longitude-latitude coordinate may then be transmitted to the first location module 11b through the first location information transmitting module 31-8. The set of longitude-latitude coordinate received by the first location module 11b, may serve as the member coordinate of the user of the first computing device 30.

In another example, the first positioning module 32 may include a positioning device. The positioning device may receive a radio signal (also denoted as signal “B”) from a base station with which the first computing device 30 is communicatively linked. The received radio signal B may then be converted to a set of longitude-latitude coordinate, which correspond with the current location of the first computing device 30 and in turn the current location of the user of the first computing device 30. The set of longitude-latitude coordinate may then be transmitted to the first location module 11b through the first location information transmitting module 31-8 to serve as the member coordinate of the user of the first computing device 30.

In still another example, the first computing device 30 may operate with an Android operating system. For such a computing device, the first positioning module 32 may include a physical layer receiver, and the first location information transmitting module 31-8 may include a portion of an APP of the application layer which may be executed by the first computing device 30. The physical layer receiver may receive a radio signal B which may be converted to a set of longitude-latitude coordinate corresponding with the current location of the first computing device 30 and in turn the current location of the user of the first computing device 30. Furthermore, the set of longitude-latitude coordinate may be read by a firmware and then passed to the portion of the APP through a public interface such as “LocationListener” of the Android operating system. Moreover, a communication link which may be compatible with the simple object access protocol (SOAP) may be built. Through the communication link, the portion of the APP may be configured to transmit the set of longitude-latitude coordinate to the first location module 11b in JavaScript object notation (JSON) or eXtensible markup language (XML) formats.

In further another example, when communicating with the location-based service system 100, the first computing device 30 may transmit packets to the location-based service system 100 through the communication network 40. Such packets may include fields containing internet protocol (IP) address which is assigned to the first computing device 30. Since such IP address is designated to the first computing device 30, it may correspond with or map to the current location of the first computing device 30 and in turn the current location of the user of the first computing device 30. In such case, the first location module 11b may retrieve the IP address from the packets transmitted by the first computing device 30, and the member coordinate of the user of the first computing device 30 may be obtained by the location-based service system 100 based on the retrieved IP address.

In the examples described above, the member coordinate of the user of the first computing device 30 may be automatically obtained by the first positioning module 32, which may include a GPS module, a positioning device, or a physical layer receiver co-operating with a portion of an APP of the application layer executed by the first computing device 30. Alternatively, the member coordinate may be obtained based on the IP address designated to the first computing device 30.

However, the user of the first computing device 30 may choose to manually input his/her location information to the location-based service system 100. In this example, the user of the first computing device 30 may input his/her location information, such as the name of a nearby landmark or an address nearby the user, through the first location information input view 31-1 disposed on the screen 31. (The terminology “view” is for I-Phone system; alternatively, it may be named as “first location information input fragment” or “first location information input activity” for Android OS system. One skilled in this art would easily understand that, in the following paragraphs, the terminologies “fragment” or “activity” may replace the terminology “view” in the naming for the elements “advertisement display view 31-2”, “point display view 31-101”, “second location information input view 21-1”, “advertisement information inputting view 21-2” and “member selecting view 21-4”). The location information which may be in JSON or XML formats may then be transmitted to the first location module 11b by another portion of the APP. After received by the first location module 11b, such location information may be converted to a set of longitude-latitude coordinate which correspond with the location of the aforementioned landmark or the address, to serve as the member coordinate of the user of the first computing device 30. Alternatively, in another example, such location information may be converted to the set of longitude-latitude coordinate corresponding with the location of the landmark or the address before being transmitted to the first location module 11b.

Such member coordinate may direct to the location of a landmark or an address nearby the user, but not the precise location of the user. Accordingly, privacy of the user may be reserved. Concerning the privacy of the user, moreover, the user may even input location information corresponds to a landmark or an address far away from the user him/herself.

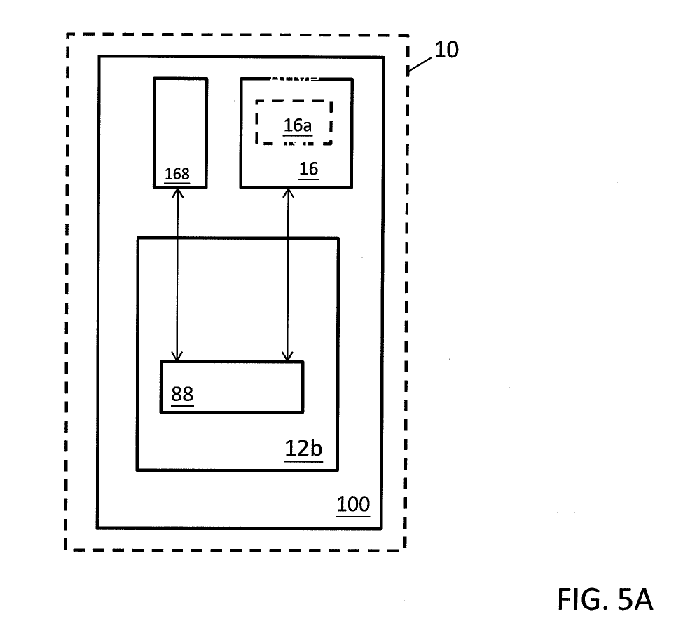

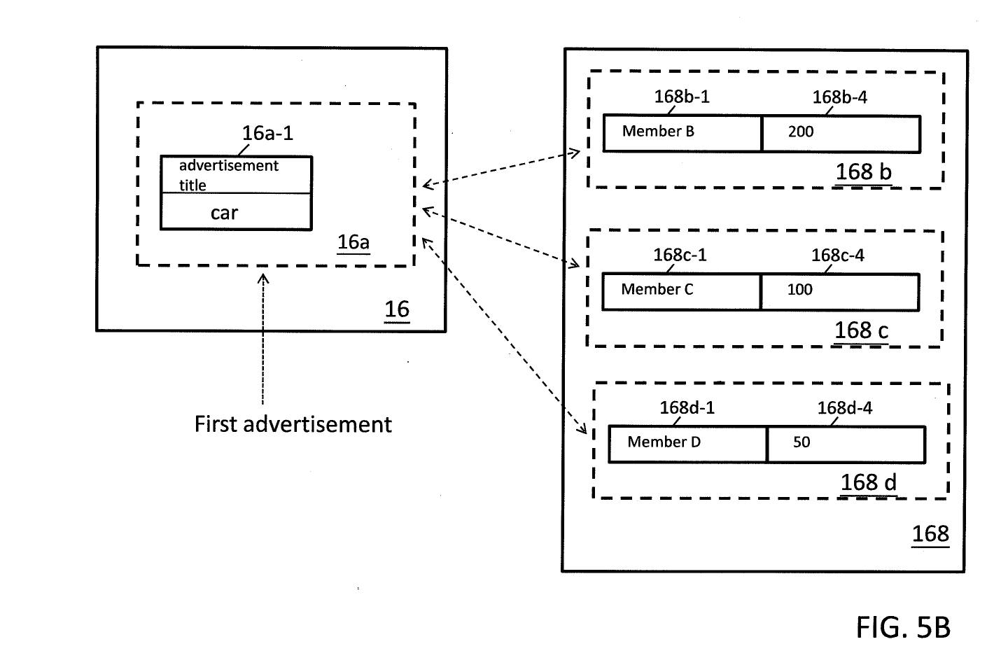

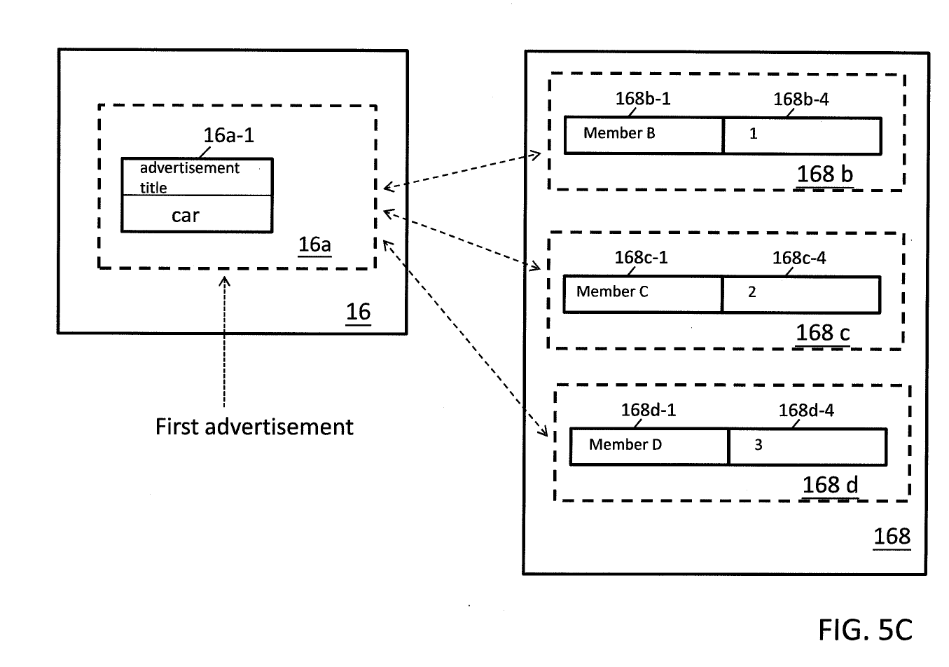

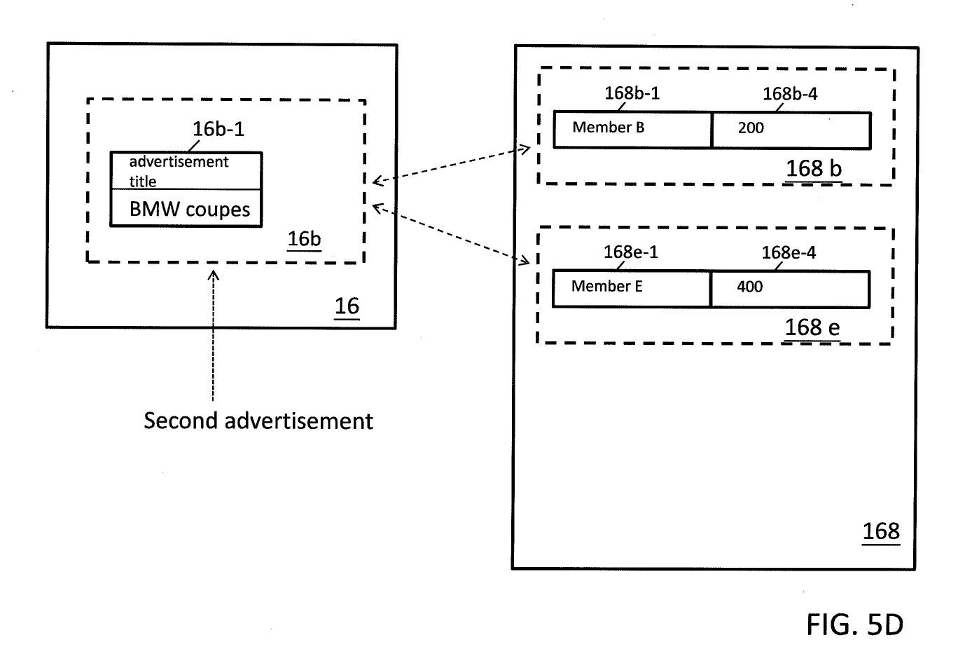

FIG. 5A is a block diagram of the location-based service system 100 in accordance with yet another example of the present invention. FIGS. 5B to 5D illustrate the advertisement effect value in accordance with an example of the present invention. Referring to FIG. 5A, the managing module 12b may be similar to the managing module 12 described and illustrated with reference to FIG. 1A except that, the managing module 12b may further include an advertisement effect value generating module 88 which may be coupled with the member database 168 and the advertisement database 16. The advertisement effect value generating module 88 may be configured to compute and generate an advertisement effect value corresponding with a member, and the generated advertisement effect value may then be stored in an fourth field 168a-4 of the advertisement database 168 as shown in FIG. 3A. Such an advertisement effect value may indicate advertisement effect on the corresponding member that may be achieved by an advertisement (or a portion of the advertisement such as a HTML file, a XML file, a JSON file or a link corresponding with the advertisement), if the advertisement is transmitted to the first or second computing device of the member. For example, referring to FIG. 5B, if a member (denoted as “member B”) is interested in a specific category of merchandise or service (such as cars), “member B” may browse or click an advertisement for a car (denoted as “first advertisement”) or even purchase the car shown by the first advertisement. Furthermore, the “member B” may introduce the first advertisement to other members who are also interested in cars. Therefore, the first advertisement may achieve greater advertisement effect on “member B”, and thus have a larger advertisement effect value corresponding with “member B”.

Members of the location-based service system 100 may be interested in various categories of merchandise or services. Thus, an advertisement for a specific category of merchandise or service may achieve different levels of advertisement effects on different members and in turn have different advertisement effect values corresponding with different members. In one example, “member B” is more interested in cars than a member denoted as “member C” and a member denoted as “member D”, and “member C” is more interested in cars than the “member D”. Thus, the first advertisement may have different advertisement effect values corresponding with “member B”, “member C” and “member D” respectively, as shown in FIG. 5B. Specifically, the first advertisement which may correspond with an advertisement file 16a of the advertisement database 16, may have a first advertisement effect value of 200, second advertisement effect value of 100 and a third advertisement effect value of 50 corresponding with “member B”, “member C” and “member D” respectively. In other words, the advertisement effect value generating module 88 may be configured to calculate the advertisement effect values based on interests of members. Furthermore, according to the corresponding advertisement effect values, “member B”, “member C” and “member D” may be ranked, and the advertisement effect values may then be converted to integers indicating such ranking, as shown in FIG. 5C.

In another example, referring to FIG. 5D, another member (denoted as “member E”) who may have higher salary than “member B”, may be more interested in cars, especially in high-priced cars (such as BMW coupes). Thus, a second advertisement for the BMW coupes, which may correspond with an advertisement file 16b of the advertisement database 16, may have a larger advertisement effect value that corresponds to “member E”. For example, the second advertisement may have advertisement effect values of 400 and 200 corresponding with “member E” and “member B” respectively. In other words, the advertisement effect value generating module 88 may be configured to calculate the advertisement effect value based on salaries of members. Similarly, when advertisement effect values are calculated, other items than interest or salary of the profile of a member, may be taken into account. For example, the gender, age, profession, address of residence, address of office and education. Furthermore, when advertisement effect values are calculated, behaviors of a member may be taken into account. For example, specific categories of merchandise or service which a member may have purchased, the number of times for which a member may have passed the advertisement coordinate of an advertisement, the number of times for which a member may have received or clicked an advertisement or input keywords relative to the advertisement. Each item of the aforementioned profile and behavior of a member may be stored in a corresponding field of the member database 168, as shown in FIGS. 3A and 3B.

In still another example, an advertisement may achieve greater advertisement effect on a member who is nearby the advertisement. Therefore, distance between an advertisement (denoted as “ad₁”) and a member (denoted as “member A”) may be taken into account when the advertisement effect value is computed. Such an advertisement effect value, in which distance is taken in account, may be further specified and thus defined as a “personal advertising effect rank (PAER(A|ad₁))”. Furthermore, behavior of other members, who may be set as friends of “member A” (denoted as “fⱼ”), may have influence on PAER(A|ad₁). Moreover, other advertisements, which may be of the same or similar categories as ad₁ (denoted as “adᵢ”), may also have influence on PAER(A|ad₁). Accordingly, PAER(A|ad₁) may be computed by the following equation:

$$\begin{matrix}P A E R ( A \vert {ad}_{1} ) = P ( X < {t}_{1} ) \frac{1 - D}{dist ( A \vert {ad}_{1} )} + \\ D {\sum }_{j = 1}^{m} \frac{{\sum }_{i = 2}^{n} P A E R ( {f}_{j} \vert {ad}_{i} )}{dist ( {f}_{j} \vert {ad}_{1} )} \\ = ( 1 - {e}^{- λ {t}_{1}} ) \frac{1 - D}{dist ( A \vert {ad}_{1} )} + \\ D {\sum }_{j = 1}^{m} \frac{{\sum }_{i = 2}^{n} P A E R ( {f}_{j} \vert {ad}_{i} )}{dist ( {f}_{j} \vert {ad}_{1} )}\end{matrix} \qquad e . q . ( 1 )$$

where:

adᵢ, iε2 to n, denote other advertisements which may be of the same or similar categories as the advertisement ad₁

fⱼ, jε1 to m, denote other members who may be set as friends of “member A”

D denotes a damping factor or a weighting factor, that may be used for adjusting the level of influence applied on PAER(A|ad₁) by friend members fⱼ

dist(A|ad₁) denotes the distance between “member A” and the advertisement ad₁ (for example, the distance between the member coordinate of “member A” and the advertisement coordinate of the advertisement ad₁)

dist(fⱼ|ad₁) denotes the distance between the friend member fⱼ and the advertisement ad₁ (for example, the distance between the member coordinate of the friend member fⱼ and the advertisement coordinate of the advertisement ad₁)

X denotes a random variable for an event that the advertisement ad₁ may be clicked or browsed or an event that the merchandise or service in the advertisement ad₁ may be purchased

t₁ denotes a time period for which the advertisement ad₁ may be posted on the location-based service system 100.

1/λ denotes an average time interval for which the “member A” may click or browse advertisements adᵢ or purchase the merchandise or service in the advertisements adᵢ

P(X<t₁) denotes a probability for which the “member A” may click or browse the advertisement ad₁ or purchase the merchandise or service in the advertisements ad₁ within the time period t₁, and Σⱼ₌₁^{m}Σᵢ₌₂ⁿPAER(fⱼ|adᵢ) denotes a summation of all the PAER for the advertisements adᵢ corresponding with the friend members fⱼ. (The factor “PAER(fⱼ|adᵢ)” may be computed in advance based on the advertisement adᵢ which has been stored in the advertisement database 16, and the computed PAER(fⱼ|adᵢ) may be also pre-stored in the advertisement database 16. Thereby, the computation of PAER(A|ad₁) may be accelerated).

For equation (1), the damping factor “D” and its corresponding factor “1−D” may be alternatively replaced by a first weighting factor “W₁” and a second weighting factor “W₂” respectively. Furthermore, the random variable “X” may not be limited to as being distributed with exponential distribution. The random variable “X” may be distributed with other types of probability or statistical distributions. Moreover, to reduce the computing complexity for calculating “PAER(A|ad₁)”, at least one of the factors, such as the distances “dist(A|ad₁)” and “dist(fⱼ|ad₁)”, the probability “P(X<t₁)” and the influence from friend members “Σᵢ₌₂ⁿPAER(fⱼ|adᵢ)” may be discarded from equation (1). For example, if the distances “dist(A|ad₁)” and “dist(fⱼ|ad₁)” are discarded from equation (1), “PAER(A|ad₁)” may be calculated by the following equation:

PAER(A|ad₁)=P(X<t₁)(1−D)+DΣⱼ₌₁^{m}Σᵢ₌₂ⁿPAER(fⱼ|adᵢ) e.q. (2)

If the distances “dist(A|ad₁)” and “dist(fⱼ|ad₁)” and the probability “P(X<t₁)” are discarded from equation (1), “PAER(A|ad₁)” may be calculated by the following equation:

PAER(A|ad₁)=(1−D)+DΣⱼ₌₁^{m}Σᵢ₌₂ⁿP(fⱼ|adᵢ) e.q. (3)

If the distances “dist(A|ad₁)” and “dist(fⱼ|ad₁)” and “Σᵢ₌₂ⁿPAER(fⱼ|adᵢ)” are discarded from equation (1) (that is, the damping factor “D” is set as zero), “PAER(A|ad₁)” may be calculated by the following equation:

PAER(A|ad₁)=P(X<t₁) e.q. (4)

In still another example, “member A” may have web-pages or websites. If the web-pages or websites of “member A” are frequently clicked or browsed by other users or members (such as friend member fⱼ of “member A”) of the location-based service system 100, “member A” may have greater influence on other users or members. In other words, if the advertisement ad₁ is transmitted to the first or second computing device of “member A” and in turn posted on the web-pages or websites of “member A”, other users or members may frequently click or browse the advertisement ad₁ through the web-pages or websites of “member A”. Accordingly, the advertisement ad₁ may have a larger advertisement effect value corresponding with “member A”, and the personal advertising effect rank “PAER(A|ad₁)” may be proportional to the number of time for which the web-pages or websites of “member A” may be browsed or referenced. Furthermore, the “PAER(A|ad₁)” may be also proportional to the number of time for which keywords relative to the advertisement ad₁ may appear on the web-pages or websites of “member A”. The number of time for which the web-pages or websites of “member A” may be browsed or referenced, may be stored in the fifth field 168a-5 and sixth field 168a-6″ of the member database 168, respectively. The number of time for which keywords relative to the advertisement ad₁ may appear on the web-pages or websites of “member A”, may be stored in the seventh field 168a-7″ of the member database 168. Therefore, the “PAER(A|ad₁)” may be calculated based on the “webpage browsed times”, the “webpage referenced times” and the “keyword appearing times” stored in the corresponding fields 168a-5, 168a-6 and 168a-7 of the member database 168. Specifically, the “webpage browsed times”, “webpage referenced times” or “keyword appearing times” may be denoted as “count(fⱼ|adᵢ)”, and the “PAER(A|ad₁)” may be calculated by the following equation:

$$\begin{matrix}P A E R ( A \vert {ad}_{1} ) = P ( X < {t}_{1} ) ( 1 - D ) + \\ D {\sum }_{j = 1}^{m} {\sum }_{i = 2}^{n} count ( {f}_{j} \vert {ad}_{i} ) P A E R ( {f}_{j} \vert {ad}_{i} ) \\ = ( 1 - {e}^{- λ {t}_{1}} ) ( 1 - D ) + \\ D {\sum }_{j = 1}^{m} {\sum }_{i = 2}^{n} count ( {f}_{j} \vert {ad}_{i} ) P A E R ( {f}_{j} \vert {ad}_{i} )\end{matrix} \qquad e . q ( 5 )$$

If other advertisements adᵢ which may be of the same or similar category as the advertisement ad₁, may be limited to have the same keywords (such as the tile, description or brand of the merchandise or service in the advertisement ad₁) as the advertisement ad₁, equation (5) may be reduced to the following equation:

$$\begin{matrix}P A E R ( A \vert {ad}_{1} ) = P ( X < {t}_{1} ) ( 1 - D ) + \\ D {\sum }_{j = 1}^{m} count ( {f}_{j} \vert {ad}_{1} ) P A E R ( {f}_{j} \vert {ad}_{1} ) \\ = ( 1 - {e}^{- λ {t}_{1}} ) ( 1 - D ) + \\ D {\sum }_{j = 1}^{m} count ( {f}_{j} \vert {ad}_{1} ) P A E R ( {f}_{j} \vert {ad}_{1} )\end{matrix} \qquad e . q ( 6 )$$

Furthermore, if the factor “probability P(X<t₁)” is discarded from equation (5) so as to reduce the computing complexity, the “PAER(A|ad₁)” may be calculated by the following equation:

PAER(A|ad₁)=(1−D)+DΣⱼ₌₁^{m}Σᵢ₌₂ⁿcount(fⱼ|adᵢ)PAER(fⱼ|adᵢ) e.q (7)

Moreover, if the factor “probability P(X<t₁)” is discarded from equation (6) so as to reduce the computing complexity, the “PAER(A|ad₁)” may be calculated by the following equation:

PAER(A|ad₁)=(1−D)+DΣⱼ₌₁^{m count(}fᵢ|adᵢ)PAER(fⱼ|adᵢ) e.q (8)

In yet another example, the personal advertising effect rank “PAER(A|ad₁)” may be only proportional to two factors. The first factor is “count(fⱼ)”, which denotes the number of time for which the web-pages or websites of “member A” may be browsed or referenced by the friend member fⱼ. The second factor is “P(X<t₁)”, which denotes the probability for which the “member A” may click or browse the advertisement ad₁ or purchase the merchandise or service in the advertisements ad₁ within the time period t₁ for the advertisement ad₁. For such case, the “PAER(A|ad₁)” may be calculated by the following equation:

$$\begin{matrix}P A E R ( A \vert {ad}_{1} ) = P ( X < {t}_{1} ) ( 1 - D ) + D {\sum }_{j = 1}^{m} count ( {f}_{j} ) \\ = ( 1 - {e}^{- λ {t}_{1}} ) ( 1 - D ) + D {\sum }_{j = 1}^{m} count ( {f}_{j} )\end{matrix} \qquad e . q . ( 9 )$$

Furthermore, if the factor “probability P (X<t₁)” is discarded from equation (9) so as to reduce the computing complexity, “PAER(A|ad₁)” may be calculated by the following equation:

PAER(A|ad₁)=(1−D)+DΣⱼ₌₁^{m}count(fⱼ) e.q. (10)

In further another example, the personal advertising effect rank “PAER(A|ad₁)” may be only proportional to (or even equivalent to) a factor “count(A)”, which denotes the number of time for which the web-pages or websites of “member A” may be browsed or referenced by any users or members of the location-based service system 100, rather than the friend members of “member A”. For such case, “PAER(A|ad₁)” may be calculated with the following equation:

PAER(A)=count(A) e.q. (11)

In a further example, the “PAER” may be converted to a positive integer, a negative integer or zero by rounding up, rounding down or rounding off.

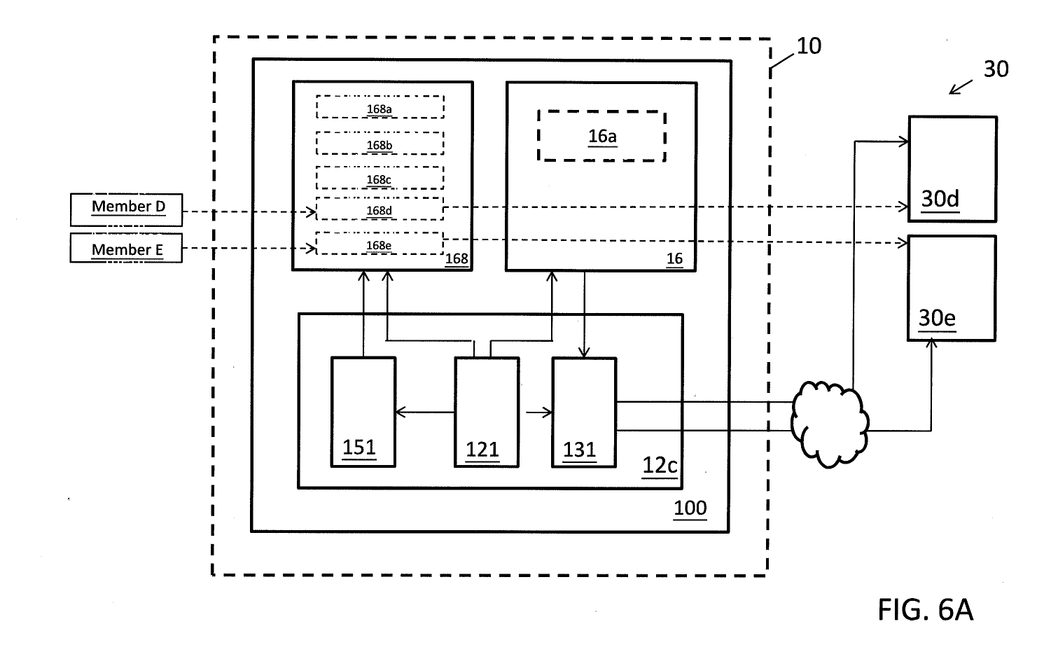

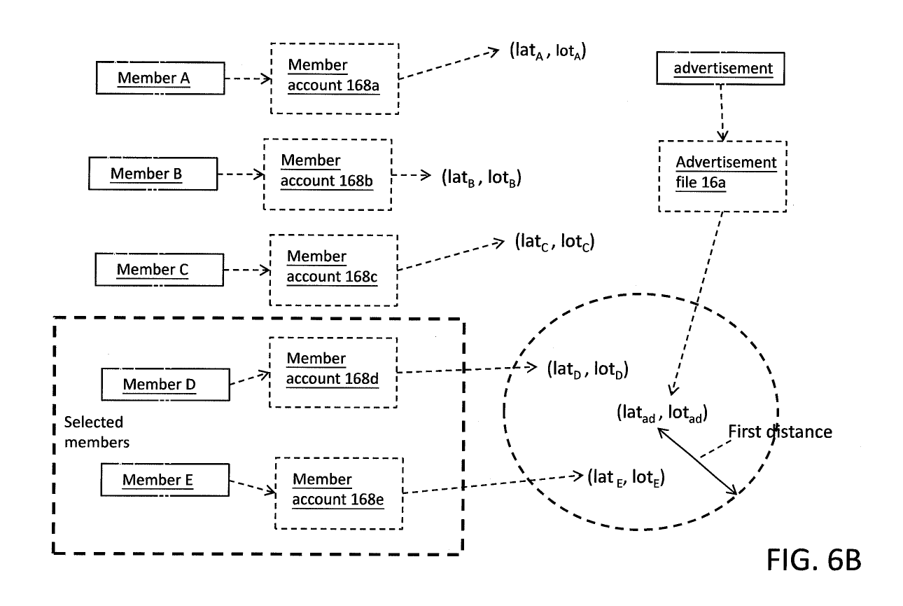

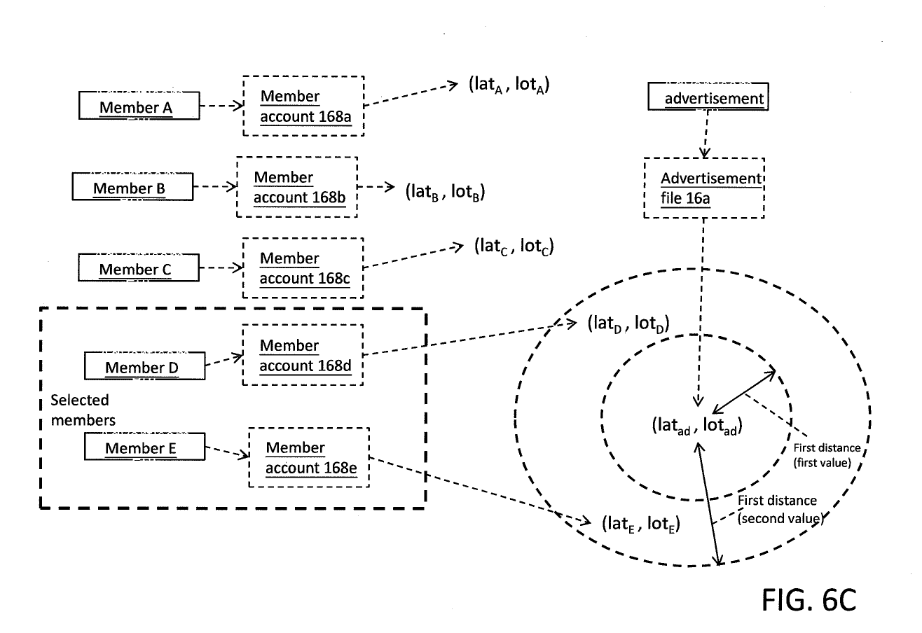

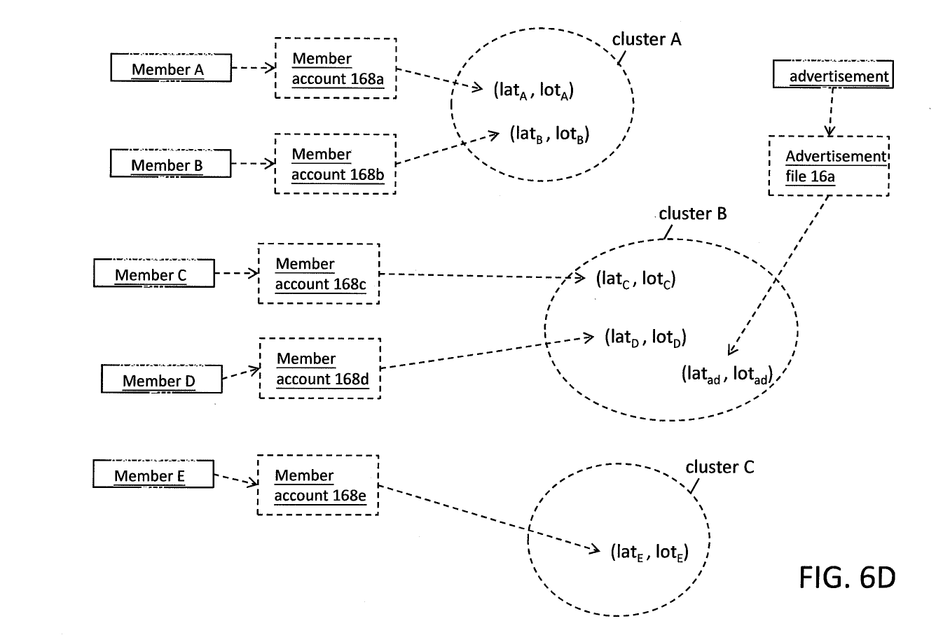

FIG. 6A is a block diagram of the location-based service system 100 and the first computing devices 30d and 30e in accordance with still another example of the present invention. FIGS. 6B to 6D illustrate the searching scheme of the searching module 121 in accordance with an example of the present invention. Referring to FIG. 6A, the managing module 12c may be similar to the managing module 12 as shown in FIG. 1A except that, the managing module 12c may further include a searching module 121, a point managing module 151 and a transmitting module 131. The searching module 121 may be coupled with the member database 168, the advertisement database 16, the point managing module 151 and the transmitting module 131. The transmitting module 131 may be coupled with the searching module 121 and the advertisement database 16, and communicatively coupled with at least one first computing device 30. The point managing module 151 may be coupled with the searching module 121 and the member database 168.

In one example, the searching module 121 may be configured to access the advertisement database 16 to access a specified advertisement file 16a stored in the advertisement database 16. The specified advertisement file 16a corresponds with an advertisement to be transmitted to at least one of members on the client sides. Furthermore, the searching module 121 may be configured to obtain an advertisement coordinate (denoted as “(lat_{ad}, lot_{ad})”) which correspond with the specified advertisement file 16a and in turn correspond with the advertisement to be transmitted. On the other hand, the searching module 121 may be configured to access the member database 168 to access a member account 168a stored in the member database 168. The member account 168a corresponds with a member (denoted as “member A”) on the client side, and “member A” may be a candidate to receive the advertisement. Moreover, the searching module 121 may be configured to obtain a member coordinate (denoted as “(lat_{A}, lot_{A})”) which correspond with the member account 168a and in turn correspond with “member A”. Then, the searching module 121 may be configured to calculate the distance between “(lat_{ad}, lot_{ad})” and “(lat_{A}, lot_{A})”. The calculation of the distance between “(lat_{ad}, lot_{ad})” and “(lat_{A}, lot_{A})” may be performed with a algorithm for computing “Distance and Azimuths Between 2 Sets of Coordinate” released by a website “U.S. Federal communication committee”.

Furthermore, the searching module 121 may be configured to determine whether the distance between “(lat_{ad}, lot_{ad})” and “(lat_{A}, lot_{A})” is smaller than or equivalent to a first distance. If confirmative, the searching module 121 may be configured to identify “member A” as a “selected member”, and the member account 168a may be identified as a “selected member account”. If negative, the searching module 121 may be configured to obtain a member coordinate (denoted as “(lat_{B}, lot_{B})”) which corresponds with another member account 168b. The member account 168b corresponds with a member denoted as “member B”. The searching module may be configured to calculate the distance between “(lat_{ad}, lot_{ad})” and “(lat_{B}, lot_{B})”. If the distance between “(lat_{ad}, lot_{ad})” and “(lat_{B}, lot_{B})” is still larger than the first distance, the searching module 121 may be configured to obtain a member coordinate (denoted as “(lat_{C}, lot_{C})”) which corresponds with still another member account 168c and in turn corresponds with a member denoted as “member C”. The searching module may be configured to calculate the distance between “(lat_{ad}, lot_{ad})” and “(lat_{C} lot_{C})”. In this manner, the searching module 121 may be configured to search a next member account stored in the member database 168, obtain a member coordinate corresponding with such member account, calculate the distance between the member coordinate and “(lat_{ad}, lot_{ad})”, and determine whether the distance is smaller than or equivalent to the first distance. In other words, the searching module may be configured to check distance between member coordinate and “(lat_{ad} lot_{ad})” for all member accounts stored in the member database 168. Thereafter, member accounts stored in the member database 168 may be identified as “selected member accounts” if the distance between the corresponding member coordinate and advertisement coordinate “(lat_{ad}, lot_{ad})” is smaller than or equivalent to the first distance. Then, the specified advertisement file 16a or a link corresponding with the specified advertisement file 16a (or both the specified advertisement file 16a and the link corresponding thereto) may be transmitted to “selected members” corresponding with the aforementioned “selected member accounts”.

Specifically, the specified advertisement file 16a and/or a link corresponding thereto may be transmitted to the “selected members” through the first computing devices which may be currently used by such “selected members”. For example, as shown in FIG. 6A, if member account 168d and member account 168e are identified as “selected member accounts”, the transmitting module 131 may be configured to transmit the specified advertisement file 16a and/or a link corresponding thereto to the selected members “member D” and “member E” through the first computing devices 30d and 30e. As discussed in the former paragraphs by reference to FIGS. 1A and 1B, the first computing device 30d and 30e are considered as “first client sides”. In other words, the specified advertisement file 16a and/or a link corresponding thereto may be transmitted to the first client sides, wherein the first client sides correspond with the selected member accounts 168d and 168e on the server side.

Moreover, since member account 168d and 168e are identified as selected member accounts, the point managing module 151 may be configured to update points of member account 168d and 168e. In one example, the points may include a grade or a amount of money which may be pre-stored in the location-based service system 100 by “member D” and “member E”. Updating the points of member account 168d and 168e may include increasing the points of member account 168d and 168e by a first amount. In addition, the searching scheme for identifying selected members and selected member accounts as mentioned above will be discussed in detail in the following paragraphs by reference to FIG. 6B.

Referring to FIG. 6B, the distance between the member coordinate (lat_{A}, lot_{A}) and the advertisement coordinate (lat_{ad}, lot_{ad}) is larger than the first distance. Likewise, the distance between the member coordinate (lat_{B}, lot_{B}) and the advertisement coordinate (lat_{ad}, lot_{ad}), and the distance between the member coordinate (lat_{C}, lot_{C} and the advertisement coordinate (lat_{ad}, lot_{ad}), are also larger than the first distance. Therefore, “member A”, “member B” and “member C” may not be identified as selected members with respect to the first distance. On the other hand, the distance between the member coordinate (lat_{D}, lot_{D}) and the advertisement coordinate (lat_{ad}, lot_{ad}), and the distance between the member coordinate (lat_{E} lot_{E} and the advertisement coordinate (lat_{ad}, lot_{ad}), are smaller than the first distance. Therefore, “member D” and “member E” may be identified as selected members with respect to the first distance. Referring back to FIG. 6A, since “member D” and “member E” are identified as selected members, the transmitting module 131 may be configured to transmit the specified advertisement file 16a (and/or the content or information included in the advertisement file 16a, and/or the link corresponding with the advertisement file 16a) to the first computing devices 30d and 30e which “member D” and “member E” may currently use or log in, respectively. In one example, the content or information included in the advertisement file 16a may be transmitted to the first computing devices 30d and 30e in the format of XML file or JSON file.

As shown in FIG. 6C, if no selected members with respect to the first distance can be identified, the value of the first distance may be increased. For example, the first distance may be increased from a first value to a second value so that “member D” and “member E” may be identified as selected members. In this manner, the value of the first distance may be manually adjusted by the administrator of the location-based service system 100 according to real practice.

FIG. 6D illustrates another searching scheme performed by the searching module in accordance with another example. Such a searching scheme may be performed by clustering so as to enhance the searching efficiency. Referring to FIG. 6D, members may be categorized as a plurality of clusters. For example, member coordinate (lat_{A}, lot_{A}) and member coordinate (lat_{B}, lot_{B}) are nearby to each other, thus “member A” and “member B” may be categorized as a same cluster (i.e., “cluster A”). Furthermore, member coordinate (lat_{C}, lot_{C}), member coordinate (lat_{D}, lot_{D}) and advertisement coordinate (lat_{ad}, lot_{ad}) are nearby to each other, thus “member C”, “member D” and the advertisement may be categorized as a same cluster (i.e., “cluster B”). Moreover, “member E” may be categorized as “cluster C”. The advertisement, “member C” and “member D” are categorized as a same cluster, thus the searching module 121 may merely calculate the distance between (lat_{C}, lot_{C}) and (lat_{ad}, lot_{ad}) and the distance between (lat_{D}, lot_{D}) and (lat_{ad}, lot_{ad}), and thereafter determine whether “member C” and/or “member D” may be identified as selected members. In other words, “member A” and “member B” which may be categorized as “cluster A”, and “member E” which may be categorized as “cluster C”, may not be taken into account. Thereby, the searching efficiency may be enhanced. In another example, a hash table which may include the plurality of clusters, may be built in the member database 168 so that the searching scheme may be simplified and the searching efficiency may thus be enhanced.

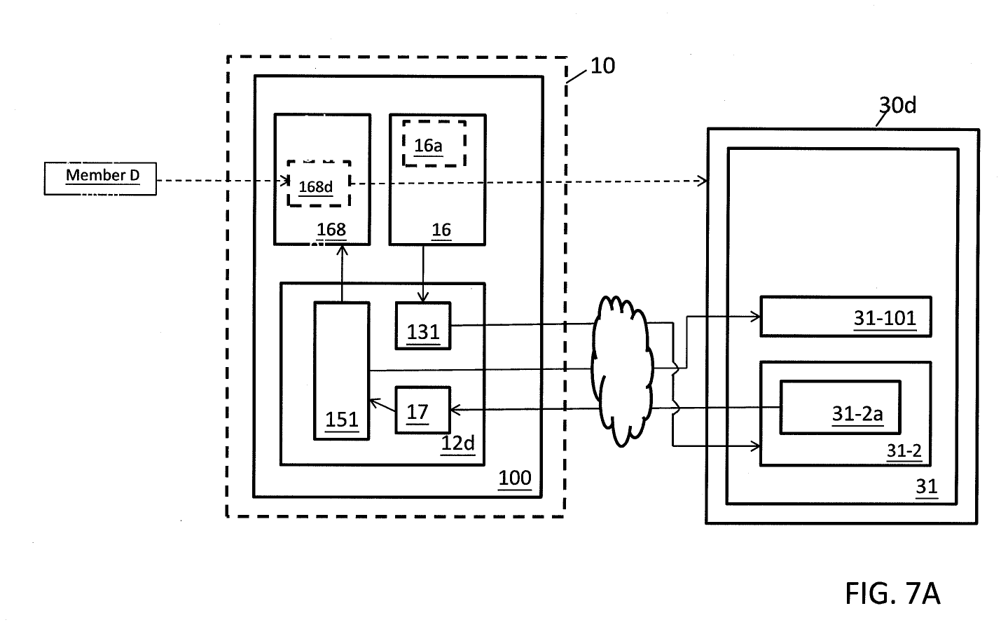

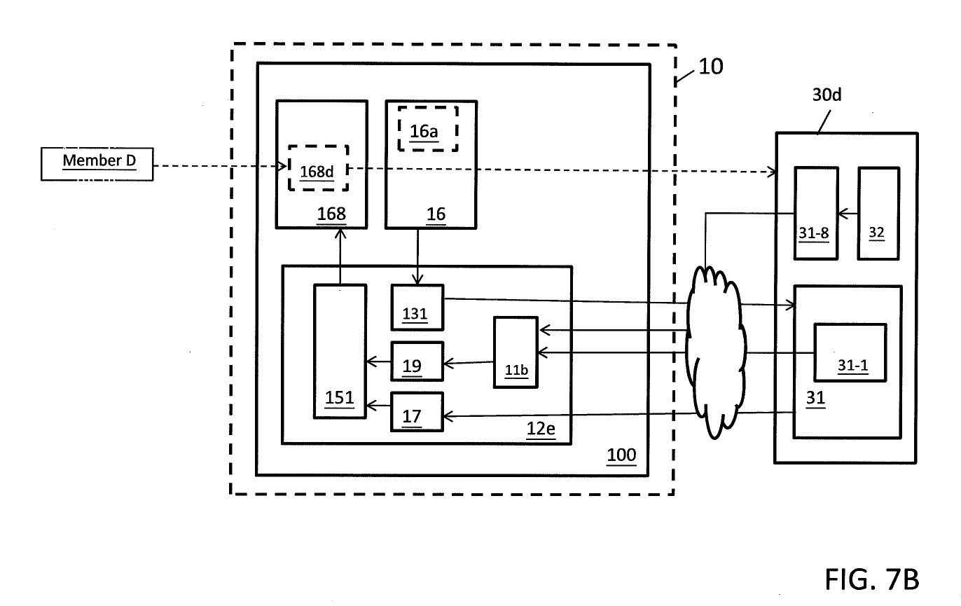

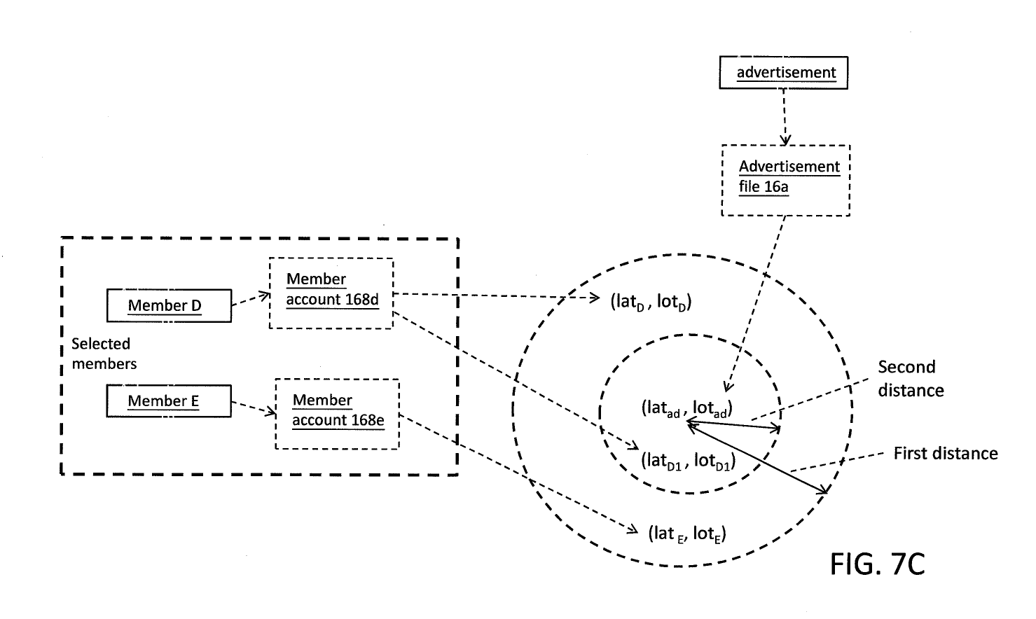

FIG. 7A is a block diagram of the location-based service system 100 and the first computing device 30d in accordance with further another example of the present invention. Referring to FIG. 7A, the first computing device 30d may be similar to the first computing device 30b as shown in FIG. 4 except that, the screen 31 of the first computing device 30d may further include a advertisement display view 31-2 and a point display view 31-101. Furthermore, the advertisement display view 31-2 may include a conforming button 31-2a (the terminology “button” may be alternatively replaced by “tab”, which may be applied to all the naming of “confirming button 31-2a” in the following paragraphs).

On the other hand, the managing module 12d may be similar to the managing module 12c as shown in FIG. 6A except that, the managing module 12d may further include a confirming module 17. The confirming module 17 may be coupled with the point managing module 151 and communicatively coupled with the confirming button 31-2a of the first computing device 30d. Moreover, the transmitting module 131 may be communicatively coupled with the advertisement display view 31-2 of the first computing device 30d.

As discussed in the former paragraphs by reference to FIGS. 6A and 6B, the distance between the member coordinate (lat_{D} lot_{D}) corresponding with the member account 168d and the advertisement coordinate (lat_{ad}, lot_{ad}) corresponding with the specified advertisement file 16a, is smaller than or equivalent to the first distance. Therefore, the member account 168d may be identified as a selected member account, and the advertisement file 16a (and/or the content or information included in the advertisement file 16a, and/or the link corresponding with the advertisement file 16a) may be transmitted to the first computing device 30d (i.e. first client side) which “member D” may currently use or log in. Specifically, the advertisement file 16a may be transmitted to the first computing device 30d through the transmitting module 131 and thereafter displayed on the advertisement display view 31-2. In one example, the advertisement file 16a may include HTML code or HTML5 code. A browser of the first computing device 30d may interpret such HTML code or HTML5 code and thereby display the advertisement as a webpage on the advertisement display view 31-2. In another example, the advertisement file 16a may include XML code or JSON code. The APP of the first computing device 30d may interpret and execute such XML code or JSON code and thereby display the content or text included in the advertisement file 16a on a first UI generated by the APP. The first UI may be disposed on the advertisement display view 31-2. Furthermore, the managing module 12d may be configured to transmit codes (such as HTML5 codes) to the browser of the first computing device 30d. By executing the codes, a second UI which include the confirming button 31-2a may be generated. Thereafter, “member D” may browse an advertisement which corresponds with the advertisement file 16a and displayed on the advertisement display view 31-2. The “member D” may further click the confirming button 31-2a to confirm that the advertisement has been received by the first computing device 30d and browsed by “member D”.

In response to the event that the confirming button 31-2a is clicked, the confirming module 17 may be configured to transmit a first confirming signal to the point managing module 151. Furthermore, in response to the first confirming signal, the point managing module 151 may be configured to update points of member account 168d. In one example, the points may include a grade or a amount of money which may be pre-stored in the location-based service system 100 by “member D”. In another example, the points may include a grade or an amount of money which may be obtained by “member D” through clicking or browsing the advertisement, or purchasing merchandise or service in the advertisement. Updating the points may include increasing the points by a first amount. The updated points may then be stored in the third field 168d-3 of the member account 168d in the member database 168. Moreover, the updated points may be displayed on the point display view 31-101.

In another example, the APP of the first computing device 30d may generate a third UI, and the confirming button 31-2a may be included in the third UI. In response to the event that the confirming button 31-2a is clicked, the first computing device 30d may be configured to transmit packets in the format of XML or JSON to the confirming module 17, and the confirming module 17 may be configured to inform the point managing module 151 to update the points of member account 168d.

FIG. 7B is a block diagram of the location-based service system 100 and the first Computing device 30d in accordance with still further another example of the present invention. Referring to FIG. 7B, the managing module 12e may be similar to the managing module 12d as shown in FIG. 7A except that, the managing module 12d may further include a first location module 11b as shown in FIG. 4 and a arriving module 19. The first location module 11b may receive the current location information (i.e., the updated location information) of the first computing device 30d. The current location information of the first computing device 30d may in turn correspond with the current location (such as the current member coordinate (denoted as “(lat_{D1}, lot_{D1})”) of “member D” who may currently use or log in the first computing device 30d.

The arriving module 19 may be coupled with the first location module 11b and the point managing module 151. Based on the current location information received by the first location module 11b, the arriving module 19 may be configured to determine whether the distance between the current (or updated) member coordinate (lat_{D1}, lot_{D1}) of “member D” and the advertisement coordinate (lat_{ad}, lot_{ad}) is smaller than a second distance. If confirmative (as shown in FIG. 7C), it may indicate an event that the first computing device 30d has received the advertisement and “member D” has browsed the advertisement through the first computing device 30d. Furthermore, it may indicate an event that “member D” may have arrived a shop or a store which locates on the advertisement coordinate (lat_{ad}, lot_{ad}), and purchase the merchandise or service in the shop or store. In response to the above events, the arriving module 19 may be configured to inform the point managing module 151 to update the points of member account 168d (such as increase the points by the first amount or the second amount).

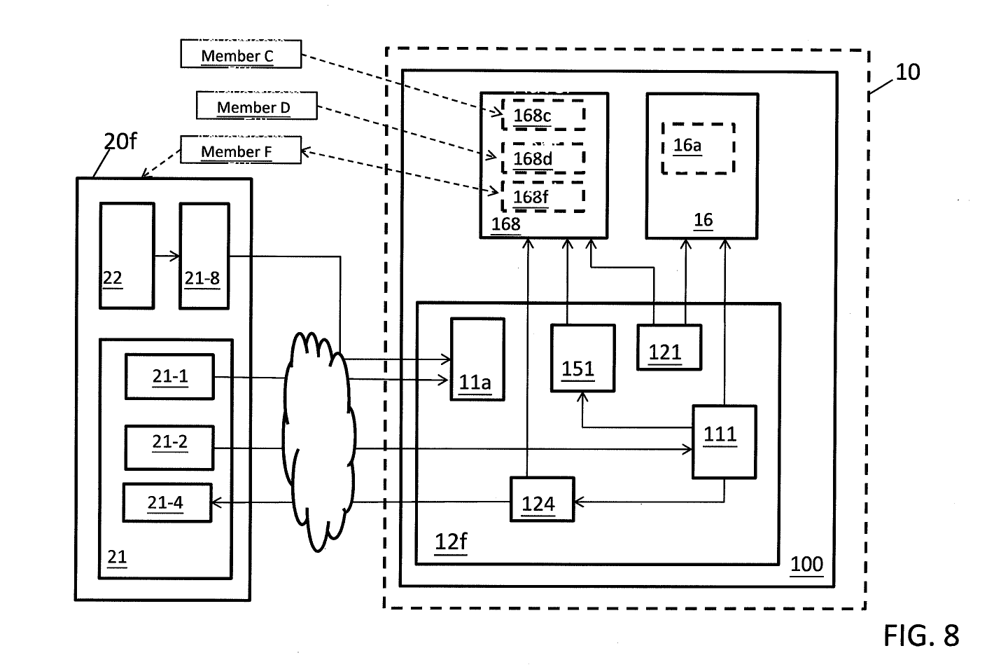

FIG. 8 is a block diagram of the location-based service system 100 and the second computing device 20f in accordance with a further example of the present invention. Referring to FIG. 8, the second computing device 20f may be similar to the second computing device 20 as shown in FIG. 4 except that, the screen 21 of the second computing device 20f may further include an advertisement information inputting view 21-2 and a member selecting view 21-4. On the other hand, the managing module 12f may be similar to the managing module 12a as shown in FIG. 4 except that, the managing module 12f may further include a advertisement receiving module 111, a searching module 121 as shown in FIG. 6A, a introducing module 124 and a point managing module 151 as shown in FIGS. 7A and 7B.

The advertisement information inputting view 21-2 may be communicatively coupled with the advertisement receiving module 111. A member (denoted as “member F”) who may post an advertisement (the advertisement corresponds with a specified advertisement file 16a in the advertisement database 16 on the server side) on the location-based service system 100 through the second computing device 20f, may input information relative to the advertisement through the advertisement information inputting view 21-2. Such advertisement information may include title, price, description, pictures, voice introduction and video introduction of merchandise or service in the advertisement. Furthermore, “member F” may input location information corresponding with the advertisement and in turn corresponding with the specified advertisement file 16a through the second location information input view 21-1. The above advertisement information and location information, which correspond with the specified advertisement file 16a, may then be received by the advertisement receiving module 111 and the second location module 11a respectively.

The advertisement receiving module 111 may be coupled with the advertisement database 16, the point managing module 151 and the introducing module 124. In response to the event that the advertisement information is received by the advertisement receiving module 111, the advertisement file 16a may be generated and stored in the advertisement database 16. Furthermore, an advertisement coordinate which correspond with the advertisement and in turn the advertisement file 16a, may be generated based on the location information received by the second location module 11a. That is, the second location module 11a may be configured to convert the location information corresponding with the advertisement to the advertisement coordinate.

Alternatively, member coordinate corresponding with “member F” may serve as the set of advertisement coordinate. In one example, the second positioning module 22 and the second location information transmitting module 21-8 may be configured to periodically calculate and update the member coordinate of “member F”, and the advertisement coordinate may thus be periodically updated. The period by which the second positioning module 22 and the second location information transmitting module 21-8 may be configured to update the member coordinate of “member F” may be adjusted, so that power consumption of the second computing device 20f may be reduced. In another example, the second location information transmitting module 21-8 may be configured to determine whether the distance between the member coordinate of “member F” calculated at a previous time point and those calculated at a present time point is larger than a predefined value. If confirmative, the second location information transmitting module 21-8 may be configured to transmit the member coordinate calculated at the present time point to the second location module 11a. Thereafter, the member coordinate of “member F” may be updated as those calculated at the present time point and then serve as an updated advertisement coordinate.

Furthermore, in response to the event that the advertisement information is received by the advertisement receiving module 111, the advertisement receiving module 111 may be configured to inform the point managing module 151 to decrease the points of member account 168f (the member account 168f corresponds with “member F”) by a third amount. In other words, in order to post the advertisement on the location-based service system, “member F” may pay an amount of money which equals the third amount of points. In one example, such “third amount” may be larger than or equal to the “second amount” or the “first amount”, wherein the “second amount” or the “first amount” is the amount by which the points of member account 168d may be increased. Regarding such member account 168d, the advertisement file 16a and/or the link corresponding with the advertisement file 16a may be transmitted to the first client side (i.e. the first computing device 30d) corresponding with the member account 168d, as discussed in the former paragraphs by reference to FIG. 7A. Furthermore, the distance between the updated member coordinate (lat_{D1}, lot_{D1}) corresponding with the member account 168d and the advertisement coordinate (lat_{ad}, lot_{ad}) corresponding with the advertisement file 16 may be smaller than or equal to the second distance, as discussed in the former paragraphs by reference to FIG. 7B.

Moreover, the advertisement receiving module 111 may be configured to inform the introducing module 124 to introduce the advertisement to selected members. Specifically, the searching module 121 may be configured to select members based on the advertisement coordinate and the searching scheme discussed in the former paragraphs by reference to FIGS. 6A and 6B. Furthermore, the selected members may be sorted based on the PAER calculated by advertisement effect value generating module 88. For example, “member C” and “member D” may be selected by the searching module 121. Furthermore, “member C” and “member D” may have PAER of 200 and 100 respectively. Therefore, “member C” which has a larger PAER than “member D”, may have a higher priority than “member D”. Based on the priority, the introducing module 124 may be configured to introduce the advertisement to “member C” prior to “member D”. Such priority may be displayed on the member selecting view 21-4.

Referring again to FIG. 7B and FIG. 8, in another example, the first computing device 30d may further include a near-field communication (NFC) module (not shown) coupled with the first location information transmitting module 31-8. The second computing device 20f may further include a near-field communication (NFC) module (not shown) coupled with the second location information transmitting module 21-8. If “member D” (who may currently use or log in with the first computing device 30d) may move to “member F” (who may post an advertisement on the location-based service system 100 through the second computing device 20f), the NFC module of the first computing device 30d may receive a NFC signal or a NFC information from the NFC module of the second computing device 20f (or vice versa: the NFC module of the second computing device 20f may receive a NFC signal or a NFC information from the NFC module of the first computing device 30d) to achieve a NFC connection. In other words, the “member D” may approach the location of the advertisement provider (i.e., “member F”), and the distance between the member coordinate of “member D” and the member coordinate of the “member F” may thus be smaller than a predefined value. Since the member coordinate of the “member F” may serve as the advertisement coordinate of the advertisement posted on the location-based service system by “member F” (the advertisement coordinate also corresponds with an advertisement file stored in the advertisement database), it may also indicate that the distance between the member coordinate corresponding with “member D” and the advertisement coordinate corresponding with the advertisement file is smaller than or equal to a predefined value. If the distance between the member coordinate corresponding with “member D” and the advertisement coordinate corresponding with the advertisement file (i.e., advertisement coordinate ((lat_{ad}, lot_{ad}))) is smaller than or equal to the second distance as shown in FIG. 7C, the point managing module 151 may be configured to update the points of “member D” and “member F” respectively (such as increase the points of “member D” by the first amount or the second amount and decrease the points of “member F” by the third amount, wherein the third amount is larger than or equal to the first amount or the second amount).

Similarly, in still another example, the first computing device 30d may further include a wireless-fidelity (Wi-Fi) module (not shown) coupled with the first location information transmitting module 31-8. The second computing device 20f may further include a Wi-Fi module (not shown) coupled with the second location information transmitting module 21-8. If “member D” (who may currently use or log in with the first computing device 30d) may move to “member F” (who may post an advertisement on the location-based service system 100 through the second computing device 20f), the Wi-Fi module of the first computing device 30d may build communication link with the Wi-Fi module of the second computing device 20f. In other words, the “member D” may approach the location of the advertisement provider (i.e., “member F”), and the distance between the member coordinate of “member D” and the member coordinate of the “member F” may thus be smaller than a predefined value. Since the member coordinate of the “member F” may serve as the advertisement coordinate of the advertisement posted on the location-based service system by “member F” (the advertisement coordinate also corresponds with an advertisement file stored in the advertisement database), it may also indicate that the distance between the member coordinate corresponding with “member D” and the advertisement coordinate corresponding with the advertisement file is smaller than or equal to a predefined value. If the distance between the member coordinate corresponding with “member D” and the advertisement coordinate corresponding with the advertisement file (i.e., advertisement coordinate ((lat_{ad}, lot_{ad}))) is smaller than or equal to the second distance as shown in FIG. 7C, the point managing module 151 may be configured to update the points of “member D” and “member F” respectively (such as increase the points of “member D” by the first amount or the second amount and decrease the points of “member F” by the third amount, wherein the third amount is larger than or equal to the first amount or the second amount).

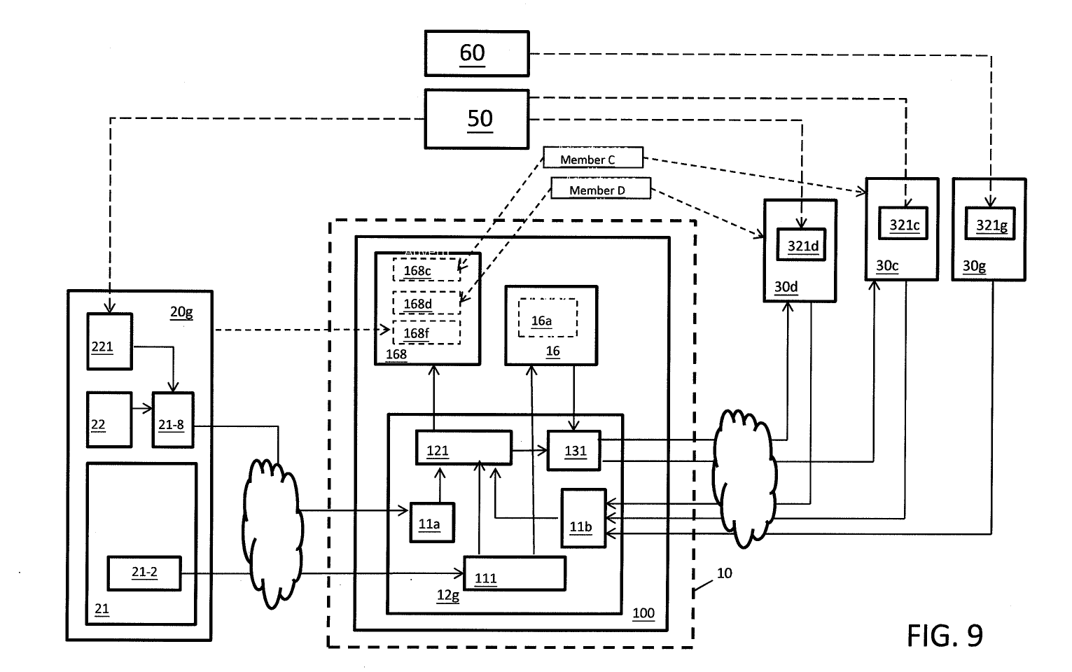

FIG. 9 is a block diagram of the location-based service system 100, the second computing device 20g and the first computing devices 30c, 30d and 30g in accordance with an example of the present invention. Referring to FIG. 9, the second computing device 20g may be similar to the second computing device 20 as shown in FIG. 4 except that, the second computing device 20g may further include a wireless network module 221. On the other hand, the managing module 12g may be similar to the managing module 12a as shown in FIG. 4 except that, the managing module 12g may further include a searching module 121 and a transmitting module 131 as shown in FIG. 6A, and a advertisement receiving module 111 as shown in FIG. 8.

The wireless network module 221 may be communicatively coupled with a base station 50 (or an access point (AP)) and receive radio signal from the base station or AP 50. Furthermore, the second location information transmitting module 21-8 may be configured to retrieve domain name or serial number of the base station or AP 50 from the radio signal. Moreover, the retrieve domain name or serial number of the base station or AP 50 may be transmitted to the second location module 11a. The domain name or serial number of the base station or AP 50 may be included in the location information of second computing device 20g.

On the other hand, similar to the operation of the managing module 12f and the second computing device 20f discussed in the former paragraphs by reference to FIG. 8, “member F” may input advertisement information through the advertisement information inputting view 21-2 and thereby post an advertisement on the location-based service system 100. The inputted advertisement information may be transmitted to the advertisement receiving module 111. In response to the event that the advertisement information is received by the advertisement receiving module 111, an advertisement file 16a corresponding with the advertisement may be generated and stored in the advertisement database 16. The domain name or serial number of the base station or AP 50 may also serve as location information corresponding with the advertisement and in turn, the advertisement file 16a. Furthermore, the advertisement receiving module 111 may be configured to inform the searching module 121 to select members from the member database 168, and the transmitting module 131 may be configured to transmit the advertisement to the selected members. The selecting scheme of the searching module 121 may be performed based on the domain name or serial number of the base station or AP 50, as will be discussed in the following paragraphs.

The searching module 121 may be configured to receive location information of the second computing device 20g from the second location module 11a. The location information of the second computing device 20g may include the domain name or serial number of the base station or AP 50 to which the second computing device 20g is communicatively coupled. Likewise, the searching module 121 may be configured to receive location information of the first computing devices 30c, 30d and 30g from the first location module 11b. The location information of the first computing devices 30c and 30d may include the domain name or serial number of the base station or AP 50 to which the first computing device 30c and 30d are communicatively coupled. On the other hand, the location information of the first computing devices 30g may include the domain name or serial number of the base station or AP 60 to which the first computing device 30g is communicatively coupled. The searching module 121 may be configured to compare the domain name or serial name of the base station or AP included in the location information of the second computing device 20g and those of the first computing devices 30c, 30d and 30g. If matched, members who currently use or log in the “matched” first computing devices may be selected. For example, the first computing devices 30c and 30d are communicatively coupled with the same base station or AP 50 as the second computing device 20g, thus the first computing devices 30c and 30d are matched with the second computing device 20g, and “member C” and “member D” may be selected. Then, the transmitting module 131 may be configured to transmit the advertisement to the selected members “member C” and “member D”.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

Further, in describing representative examples of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

I claim:

1. A computer-implemented method of managing location-based advertising in a location-based service system between a server side and client sides, said method comprising:
storing a plurality of member accounts registered in the location-based service system in a first database on the server side;
storing a plurality of advertisement files in a second database on the server side; and
selecting a first member account from the plurality of member accounts on the server side,
wherein a distance between a member coordinate corresponding with the selected first member account and an advertisement coordinate corresponding with a specified one of the advertisement files is smaller than or equal to a first distance;
transmitting at least one of the specified one of the advertisement files or a link corresponding with the specified one of the advertisement files to a first client side corresponding with the selected first member account from the server side; and
increasing a value of points of the selected first member account by a first amount on the server side.

2. The method of claim 1 further comprises:
updating the member coordinate corresponding with the selected first member account on the server side according to a current location of the first client side; and
if a distance between the updated member coordinate corresponding with the selected first member account and the advertisement coordinate corresponding with the specified one of the advertisement files is smaller than or equal to a second distance,
increasing the value of the points of the selected first member account by a second amount on the server side.

3. The method of claim 1 further comprises:
updating the member coordinate corresponding with the selected first member account on the server side according to a current location of the first client side; and
if a distance between the updated member coordinate corresponding with the selected first member account and the advertisement coordinate corresponding with the specified one of the advertisement files is smaller than or equal to a second distance,
decreasing a value of points of a second member account from the plurality of member accounts by a third amount,
wherein the second member account corresponds with the specified one of the advertisement files on the server side.

4. The method of claim 1 further comprises:
updating the member coordinate corresponding with the selected first member account on the server side according to a current location of the first client side; and
if a distance between the updated member coordinate corresponding with the selected first member account and the advertisement coordinate corresponding with the specified one of the advertisement files is smaller than or equal to a second distance,
increasing the value of the points of the selected first member account by a second amount and decreasing a value of points of a second member account from the plurality of member accounts by a third amount,
wherein the second member account corresponds with the specified one of the advertisement files on the server side.

5. The method of claim 4, wherein the third amount is larger than or equal to the second amount.

6. The method of claim 1, wherein the location-based service system comprises a second client side corresponds with the selected one of the advertisement files, the method further comprising:
receiving a first notice on the server side from the first client side or the second client side,
wherein the first notice is generated on the first client side or the second client side if a distance between a location of the first client side and the advertisement coordinate corresponding with the specified one of the advertisement files is smaller than or equal to a second distance to achieve a near-field connection (NFC) between the first client side and the second client side; and
increasing the value of the points of the selected first member account by a second amount.

7. The method of claim 1, wherein the location-based service system comprises a second client side corresponding with the selected one of the advertisement files, the method further comprising:
receiving a first notice on the server side from the first client side or the second client side,
wherein the first notice is generated on the first client side or the second client side if a distance between a location of the first client side and the advertisement coordinate corresponding with the specified one of the advertisement files is smaller than or equal to a second distance to achieve a near-field connection (NFC) between the first client side and the second client side; and
decreasing a value of points of a second member account from the plurality of member accounts by a third amount,
wherein the second member account corresponds with the specified one of the advertisement files on the server side.

8. The method of claim 1, wherein the location-based service system comprises a second client side corresponds with the selected one of the advertisement files, the method further comprising:
receiving a first notice on the server side from the first client side or the second client side,
wherein the first notice is generated on the first client side or the second client side if a distance between a location of the first client side and the advertisement coordinate corresponding with the specified one of the advertisement files is smaller than or equal to a second distance to achieve a near-field connection (NFC) between the first client side and the second client side; and
increasing the value of the points of the selected first member account by a second amount and decreasing a value of points of a second member account from the plurality of member accounts by a third amount,
wherein the second member account corresponds with the specified one of the advertisement files on the server side.

9. The method of claim 8, wherein the third amount is larger than or equal to the second amount.

10. The method of claim 1, wherein the location-based service system comprises a second client side corresponds with the selected one of the advertisement files, the method further comprising:
receiving a second notice on the server side from the first client side or the second client side,
wherein the second notice is generated on the first client side or the second client side if the first client side is in a range capable of coupling with the second client side via wireless-fidelity (Wi-Fi); and
increasing the value of the points of the selected first member account by a second amount.

11. The method of claim 1, wherein the location-based service system comprises a second client side corresponds with the selected one of the advertisement files, the method further comprising:
receiving a second notice on the server side from the first client side or the second client side,
wherein the second notice is generated on the first client side or the second client side if the first client side is in a range capable of coupling with the second client side via wireless-fidelity (Wi-Fi); and
decreasing a value of points of a second member account from the plurality of member accounts by a third amount,
wherein the second member account corresponds with the specified one of the advertisement files on the server side.

12. The method of claim 1 wherein the location-based service system comprises a second client side corresponds with the selected one of the advertisement files, the method further comprising:
receiving a second notice on the server side from the first client side or the second client side,
wherein the second notice is generated on the first client side or the second client side if the first client side is in a range capable of coupling with the second client side via wireless-fidelity (Wi-Fi); and
increasing the value of the points of the selected first member account by a second amount and decreasing a value of points of a second member account from the plurality of member accounts by a third amount,
wherein the second member account corresponds with the specified one of the advertisement files on the server side.

13. The method of claim 12, wherein the third amount is larger than or equal to the second amount.

14. The method of claim 1, wherein the member coordinate corresponding with the selected first member account comprises a longitude-latitude coordinate corresponding with a current location of the selected first client side.

15. The method of claim 1, wherein the member coordinate corresponding with the selected first member account comprises a longitude-latitude coordinate corresponding with a default location registered in the location-based service system.

16. A computer-implemented method of managing location-based advertising in a location-based service system between a server side and client sides, said method comprising:
storing a plurality of member accounts registered in the location-based service system in a first database on the server side;
storing a plurality of advertisement files in a second database on the server side; and
selecting a first member account from the plurality of member accounts on the server side,
wherein a distance between a member coordinate corresponding with the selected first member account and an advertisement coordinate corresponding with a specified one of the advertisement files is smaller than or equal to a first distance;
transmitting at least one of the specified one of the advertisement files or a link corresponding with the specified one of the advertisement files to a first client side corresponding with the selected first member account from the server side;
updating the member coordinate corresponding with the selected first member account on the server side according to a current location of the first client side; and
if a distance between the updated member coordinate corresponding with the selected first member account and the advertisement coordinate corresponding with the specified one of the advertisement files is smaller than or equal to a second distance,
increasing the value of the points of the selected first member account by at least one of a first amount or a second amount on the server side.

17. The method of claim 16 further comprises:
if a distance between the updated member coordinate corresponding with the selected first member account and the advertisement coordinate corresponding with the specified one of the advertisement files is smaller than or equal to a second distance,
decreasing a value of points of a second member account from the plurality of member accounts by a third amount,
wherein the second member account corresponds with the specified one of the advertisement files on the server side.

18. The method of claim 17, wherein the third amount is larger than or equal to the second amount.

19. The method of claim 17, wherein the third amount is larger than or equal to the first amount.

20. A computer-implemented method of managing location-based advertising in a location-based service system between a server side and a first client side or a second client side, said method comprising:
storing a plurality of member accounts registered in the location-based service system in a first database on the server side;
storing a plurality of advertisement files in a second database on the server side; and
selecting a first member account from the plurality of member accounts on the server side,
wherein a distance between a member coordinate corresponding with the selected first member account and an advertisement coordinate corresponding with a specified one of the advertisement files is smaller than or equal to a first distance;
transmitting at least one of the specified one of the advertisement files or a link corresponding with the specified one of the advertisement files to a first client side corresponding with the selected first member account from the server side;
receiving a first notice on the server side from the first client side or the second client side,
wherein the second client side corresponds with the selected one of the advertisement files,
wherein the first notice is generated on the first client side or the second client side if a distance between a location of the first client side and the advertisement coordinate corresponding with the specified one of the advertisement files is smaller than or equal to a second distance to achieve a near-field connection (NFC) between the first client side and the second client side; and
increasing the value of the points of the selected first member account by at least one of a first amount or a second amount and decreasing a value of points of a second member account from the plurality of member accounts by a third amount,
wherein the second member account corresponds with the specified one of the advertisement files on the server side.

21. The method of claim 20, wherein the third amount is larger than or equal to the second amount.

22. The method of claim 20, wherein the third amount is larger than or equal to the first amount.

23. A computer-implemented method of managing location-based advertising in a location-based service system between a server side and a first client side or a second client side, said method comprising:
storing a plurality of member accounts registered in the location-based service system in a first database on the server side;
storing a plurality of advertisement files in a second database on the server side; and
selecting a first member account from the plurality of member accounts on the server side,
wherein a distance between a member coordinate corresponding with the selected first member account and an advertisement coordinate corresponding with a specified one of the advertisement files is smaller than or equal to a first distance;
transmitting at least one of the specified one of the advertisement files or a link corresponding with the specified one of the advertisement files to a first client side corresponding with the selected first member account from the server side;
receiving a second notice on the server side from the first client side or the second client side,
wherein the second client side corresponds with the selected one of the advertisement files,
wherein the second notice is generated on the first client side or the second client side if the first client side is in a range capable of coupling with the second client side via wireless-fidelity (Wi-Fi); and
increasing the value of the points of the selected first member account by at least one of a first amount or a second amount and decreasing a value of points of a second member account from the plurality of member accounts by a third amount,
wherein the second member account corresponds with the specified one of the advertisement files on the server side.

24. The method of claim 23, wherein the third amount is larger than or equal to the second amount.

25. The method of claim 23, wherein the third amount is larger than or equal to the first amount.
